(19) United States
(12) Patent Application Publication
(10) Pub. No.: US 2018/0099367 A1
(43) Pub. Date: Apr. 12, 2018

(54) MACHINE TOOL

(71) Applicant: FIDIA S.p.A., SAN MAURO TORINESE (Torino) (IT)

(72) Inventors: Claudio Ugo Protaso REPOSSINI, Milano (IT); Giuseppe MORFINO, PINO TORINESE (Torino) (IT)

(21) Appl. No.: 15/724,337

(22) Filed: Oct. 4, 2017

(30) Foreign Application Priority Data
Oct. 10, 2016 (IT) 102016000101422

(51) Int. Cl. B23Q 11/00; B23Q 1/01; B23Q 1/44

(52) U.S. Cl. CPC B23Q 11/0042; B23Q 2220/008; B23Q 1/44; B23Q 1/017

(57) ABSTRACT

The machine tool comprises a fixed bearing structure, a movable bearing structure supported by the fixed bearing structure and displaceable with respect thereto along a horizontal direction, a tool-carrying carriage mounted vertically translatable in the movable bearing structure between an upper end position and a lower end position, situated at respective heights or levels separated by a predetermined vertical distance, and a motor adapted to cause a horizontal displacement of the movable bearing structure with respect to the fixed bearing structure and/or a vertical displacement of the tool-carrying carriage with respect to the movable bearing structure. The fixed bearing structure is configured such that the movable bearing structure is supported and driven in its displacement at a height or level intermediate between the heights or levels of the end positions of the tool-carrying carriage.

### CROSS-REFERENCE TO RELATED APPLICATIONS

This application claims priority to Italian Patent Application No. 102016000101422 filed on Oct. 10, 2016, the entire contents of which is hereby incorporated in its entirety by reference.

### FIELD OF INVENTION

The present invention relates in general to the machine tool sector, and in particular to machine tools for machining by chip removal.

### BACKGROUND

Machine tools are known of the type wherein the movable bearing structure comprises at least one vertical upright connected at its lower end with sliding guides and kinematic drive chains to an operatively fixed bearing structure which is translatable horizontally and wherein the carriage or the tool-carrying head is vertically translatable along such upright.

In such a machine, the aforementioned upright must have a high structural rigidity in all possible positions of the tool-carrying carriage, especially when the latter is in or near its upper end position.

In this respect, it has been found that when the positioning height or level of the tool-carrying carriage is increased, the flexural rigidity of the aforementioned upright is reduced substantially in proportion to the cube of such height or level. In other words, given that z is the positioning height or level of the tool-carrying carriage relative to the base of the upright, the rigidity of such upright is proportional to (l/z³).

Therefore, when the tool-carrying carriage operates in or near its upper end operating position, the flexural rigidity of the upright is considerably reduced.

### SUMMARY

An object of the present invention is to provide a machine tool which allows the aforementioned drawback of machines according to the prior art to be overcome.

This and other objects are accomplished according to the present invention with a machine tool of the initially defined type, characterized in that the fixed bearing structure is configured in such a way as to support the movable bearing structure and to allow displacement, via the associated motor means, at an intermediate height or level between the heights or levels of said tool-carrying carriage end positions.

Appropriately, said intermediate height or level corresponds substantially to the arithmetic average of the heights or levels of said end positions of the tool-carrying carriage.

In one exemplary embodiment, the machine tool of the type comprises:
a fixed bearing structure,
a movable bearing structure supported by the fixed bearing structure and displaceable with respect thereto along a horizontal direction,
a tool-carrying carriage mounted vertically translatable in the movable bearing structure between an upper end position and a lower end position, situated at respective heights or levels separated by a predetermined vertical distance, and
motor means adapted to cause a horizontal displacement of the movable bearing structure with respect to the fixed bearing structure and/or a vertical displacement of the tool-carrying carriage with respect to the movable bearing structure.

### BRIEF DESCRIPTION OF THE DRAWINGS

Further features and advantages of the present invention will become apparent from the detailed description that follows, provided by way of non-limiting example with reference to the accompanying drawings, wherein:

FIG. 1 shows, in an essentially front-side perspective view, a machine tool according to the present invention;

FIG. 2 is an enlarged scale view of the part of the machine tool indicated at II in FIG. 1;

FIG. 3 shows the machine tool according to the previous figures, essentially in a rear-side perspective view;

FIG. 4 is an enlarged scale view of the portion indicated at IV in FIG. 3;

FIG. 5 is a front elevation view of the machine tool according to the previous figures;

FIG. 6 is a side elevation view of the machine tool according to the previous figures;

FIG. 7 is a sectioned view along the line VII-VII of FIG. 5; and

FIG. 8 is a partial perspective view of a variant of embodiment of the machine tool according to the invention.

### DETAILED DESCRIPTION OF THE PREFERRED EMBODIMENTS

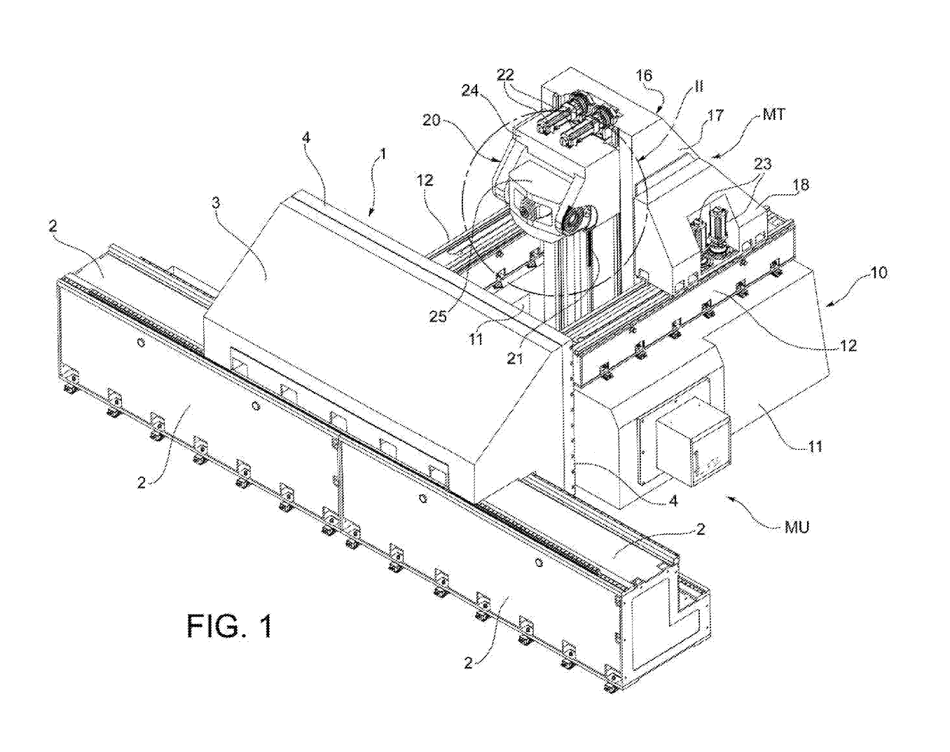

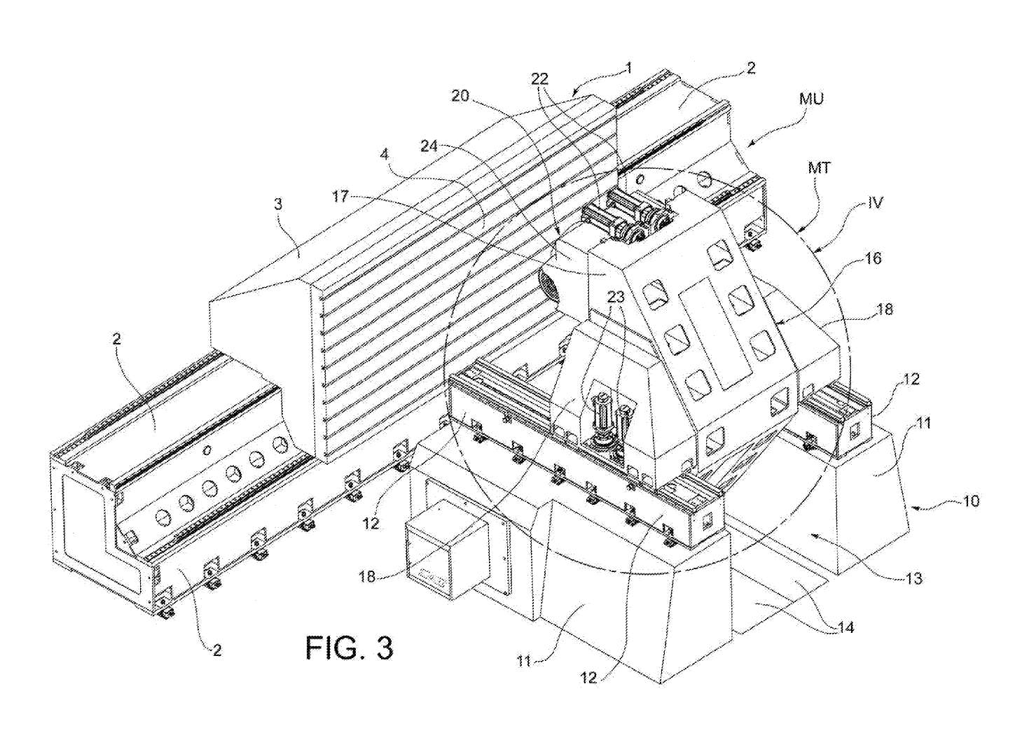

In FIGS. 1 and 3, a machining unit including a workpiece-carrying structure 1 of a type known per se and a machine tool MT according to the present invention is indicated collectively at MU.

The workpiece-carrying structure 1 in the embodiment illustrated by way of example comprises a horizontal base 2, whereon a structure 3 is mounted including a vertical workpiece-carrying table 4, facing the machine tool MT.

The machine tool MT comprises an operatively fixed bearing structure indicated collectively at 10. In the embodiment illustrated by way of example, this bearing structure 10 comprises two base bearing members 11, horizontal and parallel to each other, on the top of which respective guides 12 are fixed, which are horizontal and parallel to each other.

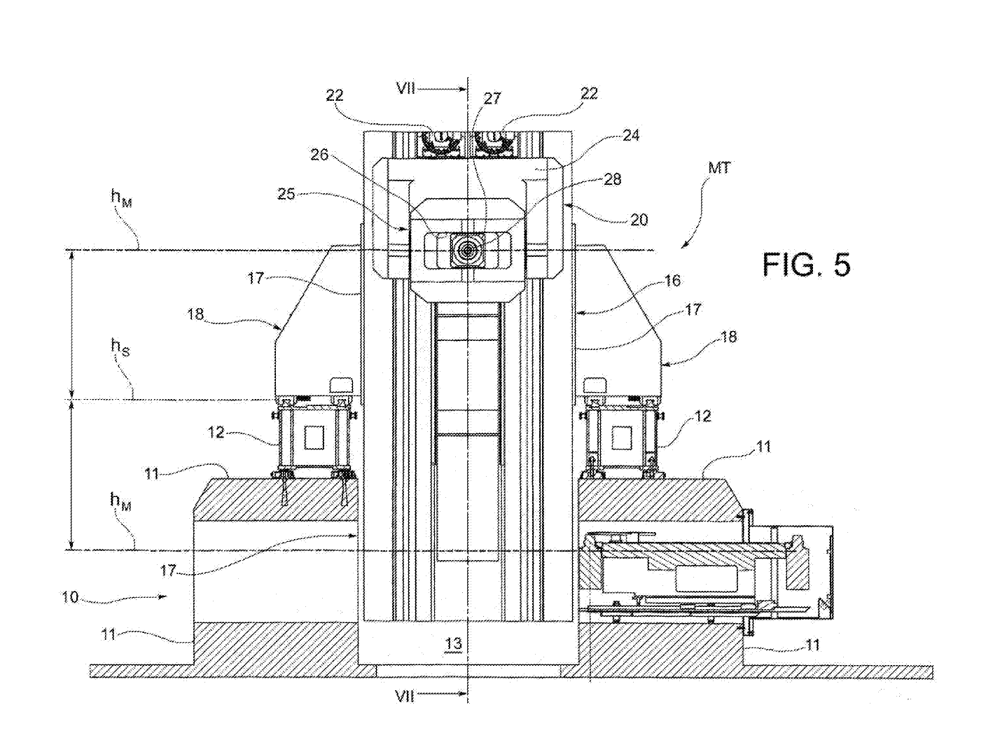

As can best be seen in FIGS. 3 and 5, a passage 13 is defined between the base bearing members 11. At the base of such passage 13 a groove 14 may be suitably formed, as is particularly apparent in FIG. 3.

The machine tool MT further comprises a movable bearing structure, collectively indicated at 16 in the drawings.

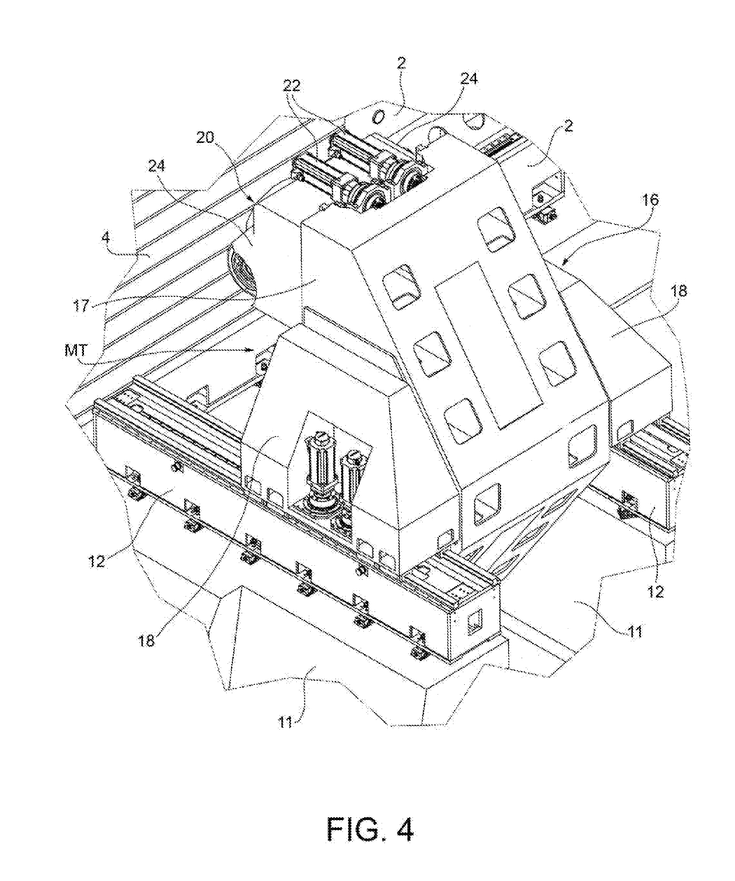

In the illustrated embodiment, the movable bearing structure 16 essentially comprises an upright 17 which, at the sides thereof opposite to the base bearing members 11, has respective motorized carriages 18 adapted to interact with the guides 12 to determine a horizontal displacement of the movable bearing structure 16 relative to the fixed bearing structure 10 (see in particular FIGS. 3 to 5).

On the front side of the upright 17, which faces the workpiece-carrying structure 1, a tool-carrying carriage is mounted vertically translatable, indicated collectively at 20.

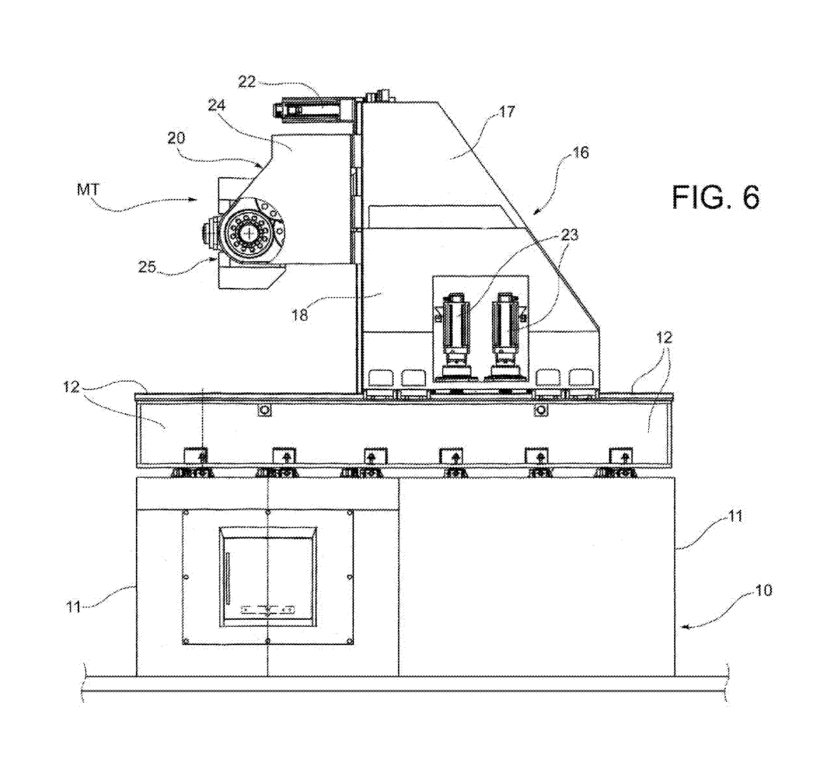

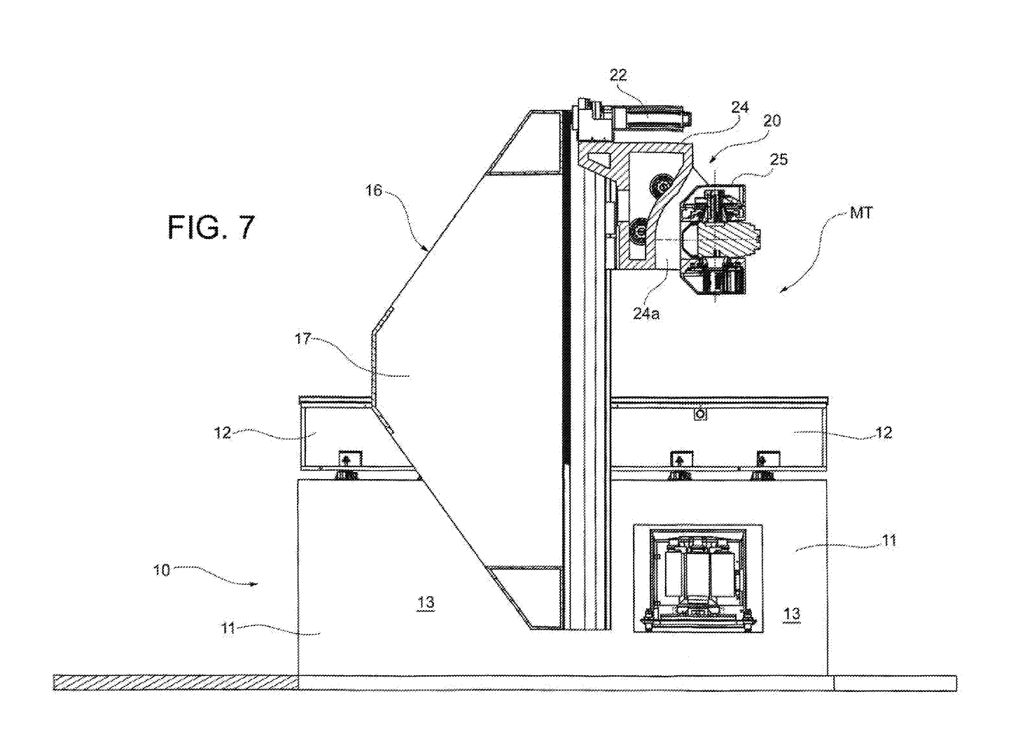

The tool-carrying carriage 20, which will be described further below, is vertically movable between an upper end position shown in FIGS. 1-7, wherein it extends near the upper end of the upright 17, and a lower end position, wherein it extends near the lower end of said upright 17.

In FIG. 5, the height or level of the tool-carrying carriage 20 corresponding to the aforementioned upper end position is indicated at h_{M}, while the height or level of the carriage corresponding to the lower end position is indicated at hₘ.

According to the present invention, the fixed bearing structure 10, 11 of the machine tool MT is configured such that the movable bearing structure (16) is supported and driven in its displacement at a height or level hₛ intermediate between the heights h_{M} and hₘ of the end positions of the tool-carrying carriage 20.

Preferably, the height or level hₛ is substantially equal to the arithmetic average of heights or levels h_{M}, hₘ, namely:

hₛ=(h_{M}+hₘ)/2.

Due to such features, with respect to a machine according to the prior art wherein the movable bearing structure is supported by the fixed structure at the height or level hₘ and where the travel of the tool-carrying carriage is substantially equal to h_{M}−hₘ, the flexural rigidity of the upright of the mobile structure of the machine according to the invention is significantly increased, even by approximately eight times when said carriage is in the upper end position.

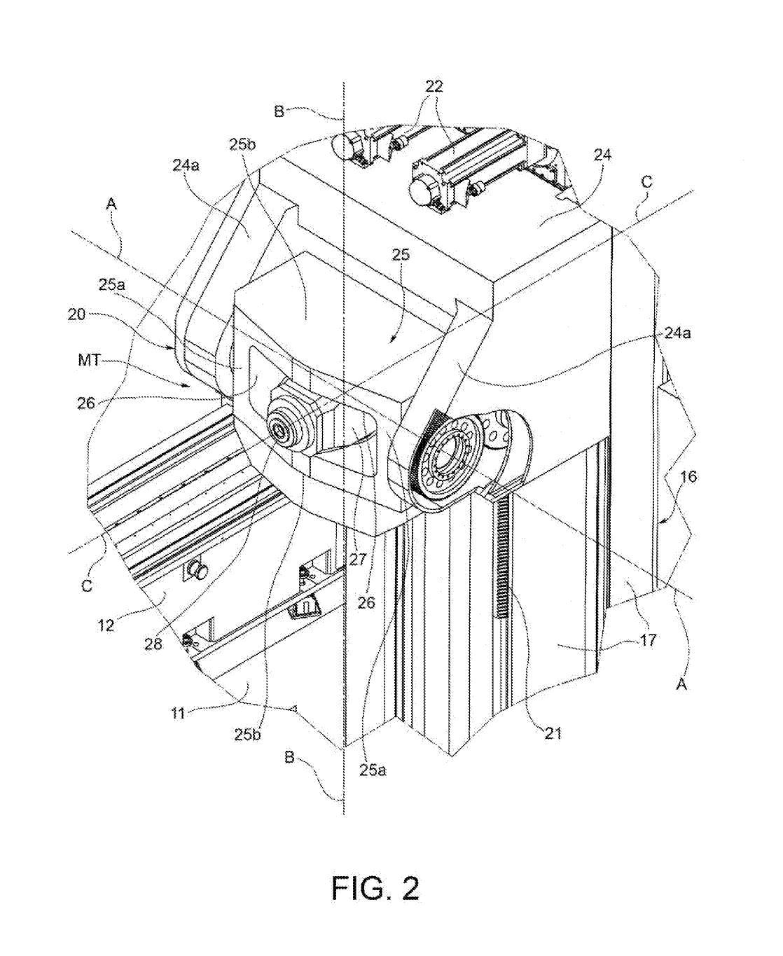

The tool-carrying carriage or head 20 is vertically translatable with respect to the upright 17 of the movable structure 16, along which only one of the guides is visible in FIGS. 1 and 2, where it is indicated at 21. Accordingly, two electric motors 22 are mounted at the top of the carriage 20, each of which is capable of actuating in rotation a respective toothed pinion that engages with a corresponding rack guide 21.

In the embodiment illustrated by way of example, each carriage 18 associated with the upright 17 is provided with a respective pair of electric motors 23 (see, for example, FIGS. 1, 3 and 4), each adapted to interact with a respective guide 12 to cause a horizontal displacement of the movable bearing structure 16 with respect to the fixed bearing structure 10.

With reference in particular to FIG. 2, in the illustrated embodiment, the tool-carrying carriage 20 comprises a support body 24 having in the front a configuration essentially in the shape of a fork, with two branches or prongs 24a facing each other.

The carriage 20 further comprises a second support body 25, essentially shaped as a substantially rectangular-shaped ring, with two portions or sides 25a substantially parallel to the branches or prongs 24a of the body 24, as well as two portions or sides 25b, orthogonal to said branches or prongs.

The support body 25 defines therewithin a through opening indicated at 26 (FIGS. 2 and 5).

The support body 25 is rotatably mounted between the branches or the prongs 24a of the support body 24 around a first axis A-A intersecting such branches or prongs 24a (see FIG. 2).

FIGS. 2 and 5 show a further support body indicated at 27, mounted rotatably in the through opening 26 of the body 25 around a second axis B-B, which is orthogonal to the axis A-A.

Preferably, but not necessarily, the axes A-A and B-B intersect at one point.

In the support body 27, a tool-carrying spindle 28 (FIGS. 2 and 5), of a type known per se, is mounted wherein a tool may be mouted, such as a milling tip.

The spindle 28 is rotatably mounted in the support body 27 around a third axis C-C, orthogonal to both the A-A and B-B axes.

Preferably, but not necessarily, the axis C-C and the axis B-B intersect each other at one point, preferably coinciding with the intersection point between the axes A-A and B-B.

The support bodies 25 and 26 and the spindle 28 are movable around the respective rotation axes A-A, B-B and C-C by means of motors of a type known per se, not shown in the drawings.

As already emphasized in the present description, the machine tool according to the present invention guarantees a very high flexural rigidity to the upright of the movable support structure in any operative position of the tool-carrying carriage.

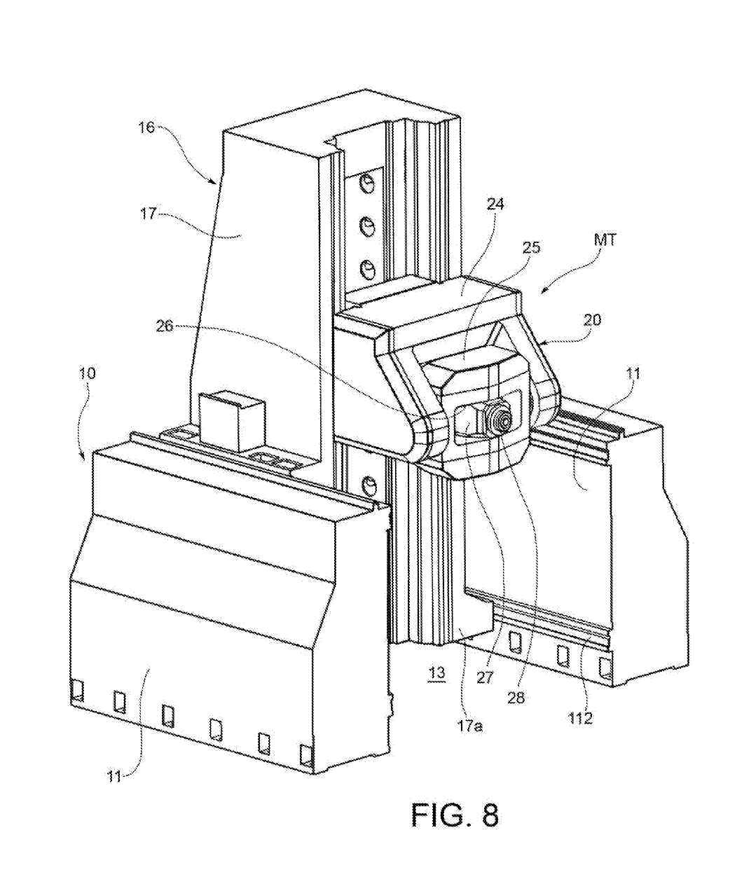

FIG. 8 partially illustrates a variant of embodiment of the machine according to the invention. In such figure, the parts/elements already described have again been given the same reference symbols used previously in the figures.

In the variant according to FIG. 8, the movable bearing structure 16 is supported and guided not only on the elements 11 at the intermediate level hₛ defined above (FIG. 5), but also at its lower end, where lateral appendixes 17a of the upright 17 engage with corresponding horizontal guides 112 provided in the base bearing members 11 of the fixed bearing structure 10.

This solution allows the flexural operative rigidity of the upright 17 to be further increased.

Naturally, without altering the principle of the invention, the embodiments and the details of construction may vary widely with respect to those described and are illustrated purely by way of non-limiting example without thereby departing from the scope of the invention as defined in the appended claims.

1. A machine tool comprising
a fixed bearing structure,
a movable bearing structure supported by the fixed bearing structure and displaceable with respect thereto along a horizontal direction,
a tool-carrying carriage mounted vertically translatable in the movable bearing structure between an upper end position and a lower end position, situated at respective heights or levels separated by a predetermined vertical distance, and
a motor adapted to cause a horizontal displacement of the movable bearing structure with respect to the fixed bearing structure and/or a vertical displacement of the tool-carrying carriage with respect to the movable bearing structure;
wherein the fixed bearing structure is configured such that the movable bearing structure is supported and driven in its displacement at a height or level intermediate between the heights or levels of said end positions of the tool-carrying carriage.

2. A machine tool according to claim 1, wherein said intermediate height or level substantially corresponds to the arithmetic average of the heights or levels of said end positions of the tool-carrying carriage.

3. A machine tool according to claim 1, wherein
the fixed bearing structure comprises two base bearing members having an associated horizontal guide along which the movable bearing structure is displaceable, and
the movable bearing structure has an associated vertical guide along which the tool-carrying carriage is displaceable.

4. A machine tool according to claim 1, wherein on each of said base bearing members there is fixed a respective horizontal guide, and between said base bearing members there is defined a passage in which part of the movable bearing structure extends, which on opposite sides has respective motorized carriages adapted to interact with said guides to cause a horizontal displacement of the movable bearing structure with respect to the fixed bearing structure.

5. A machine tool according to claim 1, wherein the movable bearing structure is provided with at least one vertical guide and the tool-carrying carriage is motorized and is adapted to interact with said at least one vertical guide to perform a vertical displacement with respect to the movable bearing structure.

6. A machine tool according to claim 1, wherein the movable bearing structure at its lower end is further supported in a horizontally displaceable manner by the fixed bearing structure.

7. A machine tool according to claim 3, wherein the fixed bearing structure comprises two base bearing members having an associated horizontal guide along which the movable bearing structure is displaceable, and
the movable bearing structure has an associated vertical guide along which the tool-carrying carriage is displaceable, and wherein the lower end of the movable bearing structure has appendixes engaged in corresponding horizontal guides predisposed in said base bearing members.
